(19) United States
(12) Patent Application Publication
(10) Pub. No.: US 2007/0216279 A1
(43) Pub. Date: Sep. 20, 2007

(54) Image display

(76) Inventors: Naohiro Horiuchi, Hitachi (JP); Takuya Takahashi, Hitachi (JP); Takaaki Suzuki, Kasama (JP); Etsuko Nishimura, Hitachiota (JP); Toshiaki Kusunoki, Tokorozawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/657,694

(22) Filed: Jan. 25, 2007

(30) Foreign Application Priority Data
Mar. 17, 2006 (JP) 2006-074425

(51) Int. Cl. H01J 19/06; H01J 1/62

(52) U.S. Cl. 313/311; 313/495

(57) ABSTRACT

It is an object of the present invention to provide an image display using a thin film electronic source having a structure for separating picture elements in a self-alignment manner. The structure of bus wiring (scanning line) for powering the electronic source is formed by a stacked structure including a lower layer 17 made of an alloy of CrMo, an intermediate layer 18 made of Al or an alloy of Al, and an upper layer 19 made of Cr, from a cathode substrate 10. The CrMo alloy in the lower layer 17 includes 30 wt % or more of Mo. Such a stacked structure can be used to process one side of the lower layer 17 to form an undercut relative to the intermediate layer 18. The undercut serves as a picture element separating structure in sputtering of an upper electrode 13 of the electronic source and achieves picture element separation in a self-alignment manner.

### FIELD OF THE INVENTION

The present invention relates to an image display of a self-luminous type using an array of thin-film electronic sources.

### BACKGROUND OF THE INVENTION

Displays using small electronic sources which can be integrated are referred to as FEDs (Field Emission Displays). The electronic sources thereof include a surface conductive electronic source, an MIM (Metal Insulator Metal) electronic source described in Patent Document 1 and including a stack of metal/insulator/metal, and the like.

The MIM electronic source is formed of a first electrode (lower electrode) formed on a substrate, a second electrode (upper electrode) placed above the first electrode, and an electron accelerating layer sandwiched between the upper electrode and the lower electrode. A voltage is applied between the electrodes to emit electrons from the upper electrode.

An exemplary FED using the MIM electronic source is provided by arranging MIM electronic sources on a substrate in a matrix and forming an upper bus electrode (scanning line) for powering an upper electrode and a lower electrode in order to drive the matrix from outside the panel. The electronic sources are powered and thus emit electrons which then cause a fluorescent material to emit light, thereby displaying an image.

When an image is displayed with the matrix driving, the scanning lines are used to power all the electronic sources on the same scanning line simultaneously. Thus, a voltage drop due to wire resistance on the scanning line presents a significant problem particularly in forming a large image display. The wire resistance must be reduced to solve the problem.

To reduce the wire resistance on the bus electrode, an effective approach is to use a material with a low specific resistance and ease of formation into a thicker film. Cu (copper) has a small specific resistance next to Ag (silver) and a high spatter deposition rate. Patent Document 2 below is an example of the use of Cu for the upper bus wire. However, Cu is likely to be oxidized and easily oxidized from heat in the process of panel manufacture. To prevent the oxidation, Cu is sandwiched between metal (such as Cr (chromium)) having resistance to heat and oxidation.

### (Patent Document 1) JP-A-7-65710

### (Patent Document 2) JP-A-2004-363075

### BRIEF SUMMARY OF THE INVENTION

The upper bus electrode has a mechanism for separating picture elements in a self-alignment manner. One side of the Cr layer closer to the substrate than the Cu layer is protruded from the Cu layer to provide a contact portion for ensuring connection to the upper electrode. And on the other side thereof, an undercut is formed by using the Cu layer as a mask to provide a canopy. The canopy serves as the structure for separating picture elements.

The upper bus electrode needs to have a low resistance. It also must have heat resistance since its manufacture process includes a step at high temperature. In addition, it should have a structure for separating picture elements in a self-alignment manner.

The abovementioned structure including the Cu layer sandwiched between the metal with heat resistance cannot prevent oxidation of the Cu layer on the side. If the oxidized Cu layer breaks the bus electrode or the undercut of the picture element separating structure, an image cannot be displayed normally. In view of the foregoing, it is an object of the present invention to provide an image display which can solve the abovementioned problems.

Other object, feature and advantages of the invention will become apparent from the following description of the embodiments of the invention taken in conjunction with the accompanying drawings.

### BRIEF DESCRIPTION OF THE DRAWINGS

FIG. 1 shows the structure of an MIM electronic source and its operation principles;

FIG. 2 is a plan view schematically showing an image display using the MIM electronic source according to the present invention;

FIG. 3 shows a manufacture step of the MIM electronic source;

FIG. 4 shows a manufacture step of the MIM electronic source subsequent to FIG. 3;

FIG. 5 shows a manufacture step of the MIM electronic source subsequent to FIG. 4;

FIG. 6 shows a manufacture step of the MIM electronic source subsequent to FIG. 5;

FIG. 7 shows a manufacture step of the MIM electronic source subsequent to FIG. 6;

FIG. 8 shows a manufacture step of the MIM electronic source subsequent to FIG. 7;

FIG. 9 shows a manufacture step of the MIM electronic source subsequent to FIG. 8;

FIG. 10 shows a manufacture step of the MIM electronic source subsequent to FIG. 9;

FIG. 11 shows a manufacture step of the MIM electronic source subsequent to FIG. 10;

FIG. 12 shows a manufacture step of the MIM electronic source subsequent to FIG. 11;

FIG. 13 shows a manufacture step of the MIM electronic source subsequent to FIG. 12;

FIG. 14 is a schematic diagram for explaining the method of forming a picture element separating structure;

FIG. 15 shows the relationship between the etching rate ratio of CrMo/Cr and the content of Mo;

FIG. 16 shows the relationship between the etching rate of CrMo and the content of Mo;

FIG. 17 shows another manufacture step of the MIM electronic source subsequent to FIG. 8;

FIG. 18 shows a manufacture step of the MIM electronic source subsequent to FIG. 17;

FIG. 19 shows a manufacture step of the MIM electronic source subsequent to FIG. 18;

FIG. 20 shows a manufacture step of the MIM electronic source subsequent to FIG. 19;

FIG. 21 shows a manufacture step of the MIM electronic source subsequent to FIG. 20;

FIG. 22 shows the relationship between the content of Cr of CrMo and the etching rate ratio of CrMo/Al;

FIG. 23 shows the relationship between the content of Cr of CrMo and the etching rate of CrMo;

FIG. 24 shows the relationship between the content of Ni of an alloy of CrMoNi and the thickness of a surface oxidation film (oxidation resistance); and

FIG. 25 is a section view showing the alloy of CrMoNi (SEM photograph).

### BRIEF DESCRIPTION OF THE DRAWINGS

10 CATHODE SUBSTRATE
11 LOWER ELECTRODE
12 INSULATING LAYER (TUNNEL INSULATING LAYER)
13 UPPER ELECTRODE
14 PROTECTION INSULATING LAYER
15 INTERLAYER FILM
16 CONTACT PORTION
17 METAL FILM LOWER LAYER
18 METAL FILM INTERMEDIATE LAYER
19 METAL FILM UPPER LAYER
21 SCANNING LINE
25 RESIST FILM
26 RESIST FILM
27 RESIST FILM
28 RESIST FILM
30 SPACER
50 SIGNAL LINE DRIVING CIRCUIT
60 SCANNING LINE DRIVING CIRCUIT
111 RED FLUORESCENT MATERIAL
112 GREEN FLUORESCENT MATERIAL
113 BLUE FLUORESCENT MATERIAL
120 BLACK MATRIX

### DETAILED DESCRIPTION OF THE INVENTION

To achieve the abovementioned object, the present invention uses Al (aluminum) or an alloy of Al having a low resistance and oxidation resistance instead of Cu for the structure of an upper bus electrode. A layer made of the alloy of Al is sandwiched between a layer made of Cr (chromium) and an alloy of CrMo of Cu and Mo (molybdenum).

The CrMo layer, the Al or Al alloy layer, and the Cu layer are stacked in this order from a glass substrate. The lower layer of the upper bus electrode of such a layered structure is selectively etched such that one side is connected to an upper electrode and the other side forms an undercut relative to the Al layer to provide a canopy structure. In forming the undercut in the lower layer, the upper layer is etched simultaneously. When the upper layer is etched to expose Al and increase the area of Al in contact with the etchant as compared with the area of Cr, the etching of Cu is interrupted due to cell reaction.

In other words, the amount of the undercut in the lower layer is determined by the time period taken for the etching of the upper layer. To provide the amount of the undercut effective in separating picture elements, the thickness of the upper layer can be increased such that a long time is taken to form the undercut. However, Cr has a large tensile strength and thus a thick layer of Cr tends to be stripped. So, the Cr layer cannot be increased in thickness. The lower layer made of the CrMo alloy allows control of the etching rate with local cell reaction to selectively etch the lower layer to ensure the necessary amount of the undercut.

The CrMo alloy in the lower layer includes 30 wt % or higher of Mo, preferably 60 wt % or lower, and may fall within the range.

When the CrMo layer in the lower layer and the Al or Al alloy layer in the intermediate layer are collectively etched, the CrMo alloy in the lower layer preferably includes 2.5 wt % to 8 wt % of Cr (with 92 wt % to 97.5 wt % of Mo), and may fall within the range.

The lower layer may be formed of an alloy of CrMoNi containing Cr, Mo, and Ni (nickel), with 25 wt % or lower of Ni. In this case, Ni is included and correspondingly the content of Mo is reduced.

Any one of Cr, Al, and CrMo alloy have heat resistance, and the picture element separating structure is not broken in a manufacture step at high temperature. The necessary undercut is reliably formed to separate picture elements in this way, so that an image display can be produced.

The use of the abovementioned structure enables production of an image display of a self-luminous type using an array of thin film electronic sources.

A best embodiment of the present invention will hereinafter be described in detail with reference to the drawings. First, an image display according to the present invention will be described with an exemplary image display using an MIM electronic source.

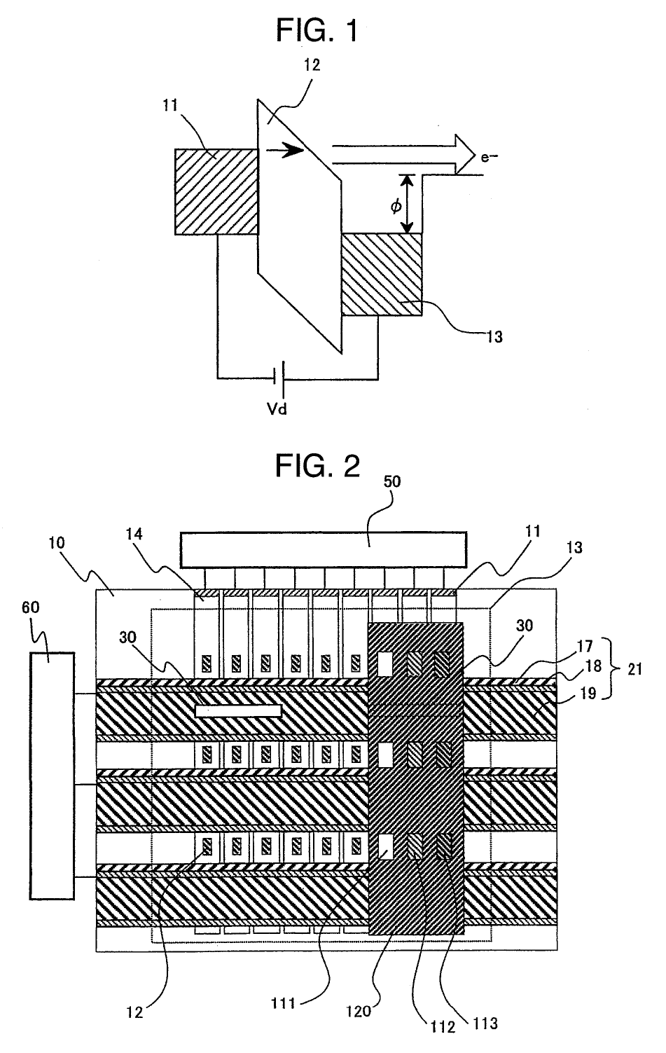

FIG. 1 shows the structure of the MIM electronic source and its operation principles. When a driving voltage Vd is applied between an upper electrode 13 and a lower electrode 11 to provide an electric field of approximately 1 to 10 MV/cm in an insulating layer 12, electrons near the Fermi level in the lower electrode 11 pass through the barrier due to the tunnel phenomenon, and are injected into the conduction band of the insulating layer 12 serving as an electron accelerating layer and changed into hot electrons which then flow into the conduction band of the upper electrode 13. Some of the hot electrons that reach the surface of the upper electrode 13 with energy equal to or higher than the work function φ of the upper electrode 13 are ejected into a vacuum.

### EXAMPLE 1

FIG. 2 is a plan view schematically showing an exemplary image display using the MIM electronic source according to the present invention. FIG. 2 mainly shows the plane of a cathode substrate 10 having electronic sources as one of the substrates. The other fluorescent surface substrate having a fluorescent material formed thereon is shown partially only by a black matrix 120 and fluorescent materials 111, 112, and 113 on its inner face. The cathode substrate 10 and the fluorescent surface substrate are placed opposite to each other, the peripheries thereof are sealed with a seal member, and the inside thereof is evacuated, thereby forming a display panel.

The cathode substrate 10 is provided with a lower electrode 11 forming a signal line and connecting to a signal line driving circuit 50, and a scanning line 21 connected to a scanning line driving circuit 60 and arranged perpendicularly to the signal line. The scanning line 21 is connected to an upper electrode 13. The lower electrode 11 and the upper electrode 13 are used to apply a voltage to the insulating layer 12 to emit electrons.

The fluorescent surface substrate having the fluorescent material formed thereon is formed of the black matrix 120 for the purpose of increasing the contrast, the red color fluorescent material 111, the green fluorescent material 112, and the blue fluorescent material 113. The fluorescent material is formed, for example, of Y₂O₂S:Eu (P22-R) for red, ZnS:Cu, Al (P22-G) for green, and ZnS:Ag, Cl (P22-B) for blue. The black matrix 120 is shown only partially in the image display area for the convenience in the figure.

A spacer 30 is placed above the scanning line 21 of the cathode substrate 10 such that it is hidden below the black matrix 120 of the fluorescent surface substrate.

Example 1 is the image display characterized in that the scanning line 21 is formed by stacking a CrMo alloy layer containing 30 wt % or higher of Mo, an Al or Al alloy layer, and a Cr layer from the cathode substrate 10. This structure allows an undercut to be formed reliably to produce the image display. The details will hereinafter be described in conjunction with the manufacture process of the MIM electronic source.

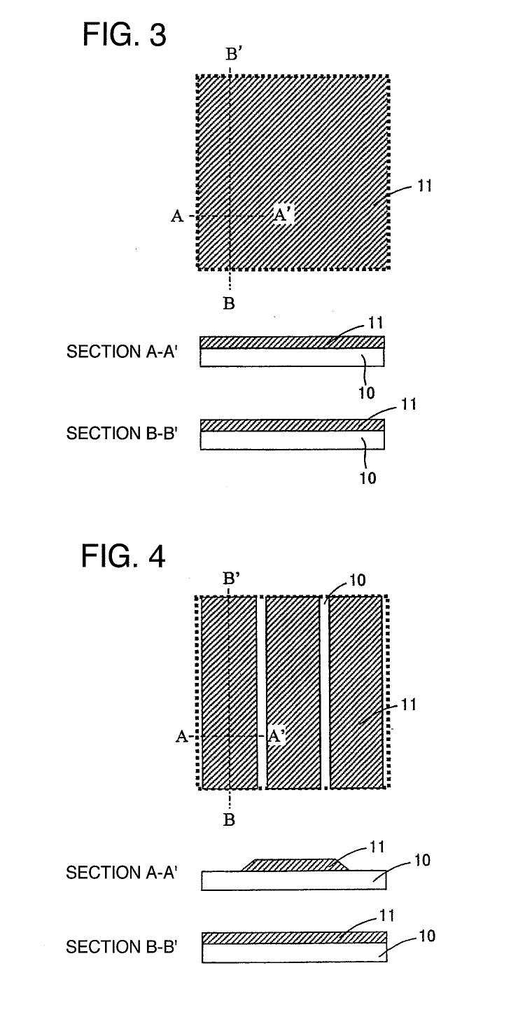

FIGS. 3 to 13 are diagrams for explaining the manufacture process of the MIM electronic source forming one picture element in the image display according to the present invention. The steps are shown in order from FIGS. 3 to 13. The one picture element herein mentioned is formed of a plurality of sub picture elements (hereinafter also referred to as subpixels) for displaying different colors. In Example 1, the sub picture elements for red, green, and blue are used.

First, as shown in FIG. 3, a metal film for the lower electrode 11 was deposited on the insulating cathode substrate 10 made of glass or the like. Al can be used, for example, as the material of the lower electrode 11 since it has a low resistance and can provide an insulating film of high quality through oxidation. Ti, Zr, Nb, Ta, and Si may be used instead of Al. In this case, An alloy of AlNd including 10 wt % of Nd (neodymium) added was used. For example, sputtering can be used for the deposition. The thickness of the film was 10 nm.

As shown in FIG. 4, after the deposition, a patterning step and an etching step were performed to form the lower electrode 11 in stripes. The width of the electrode depends on the size and the resolution of the image display, but substantially corresponds to the subpixel pitch, approximately 100 to 200 μm. For the etching, for example, wet etching can be performed with a mixed solution of phosphoric acid, acetic acid, and nitric acid. Since the electrode has a simple stripe structure having a large width, the patterning of a resist can be performed through inexpensive proximity exposure or printing.

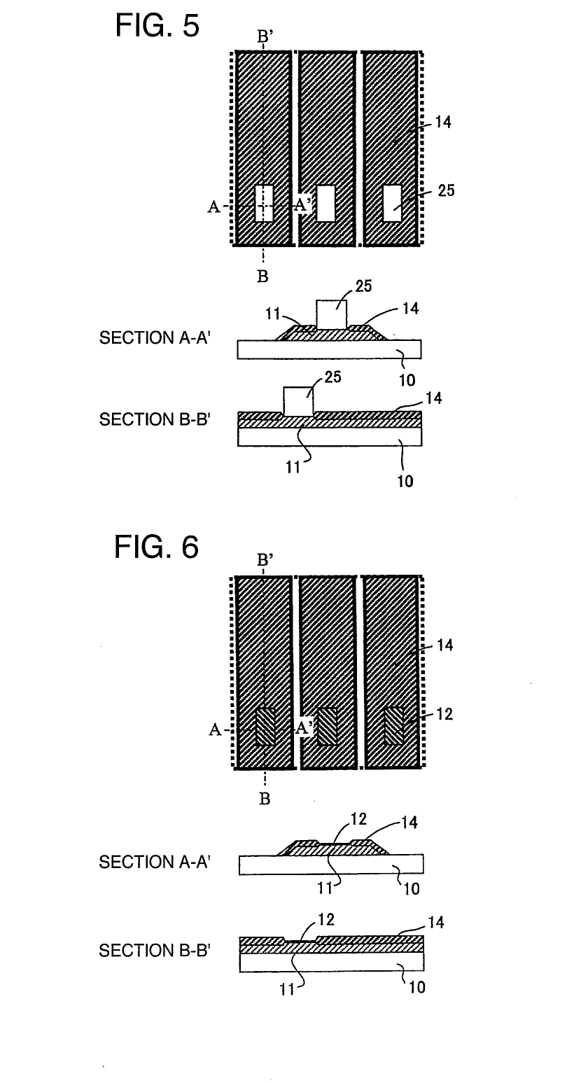

Next, as shown in FIG. 5, a protection insulating layer 14 was formed to limit an electron emitting portion and to prevent the concentration of an electric field on the edges in the lower electrode 11. First, a portion on the lower electrode 11 that would serve as the electron emitting portion was masked by a resist film 25 and the remaining portion was selectively anodized thickly to provide the protection insulating layer 14. With an anodizing voltage of 100 V, the protection insulating layer 14 having a thickness of approximately 136 nm could be formed.

Next, as shown in FIG. 6, the insulating layer 12 was formed. The resist film 25 was removed to anodize the remaining surface of the lower electrode 11. For example, with an anodizing voltage of 6 V, the insulating layer 12 having a thickness of approximately 10 nm was formed on the lower electrode 11.

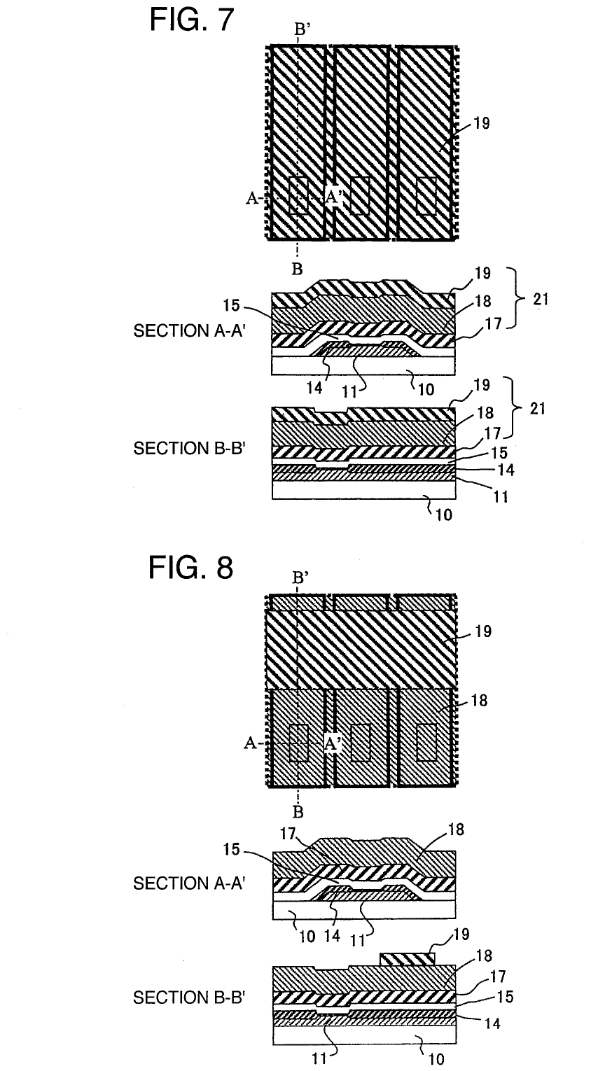

Next, as shown in FIG. 7, an interlayer film 15 was formed, for example, through sputtering. As the interlayer film 15, for example, a film made of silicon oxide, silicon nitride, or silicon may be used. In this case, the film of silicon nitride was used with a thickness of 100 nm. The interlayer film 15 serves to fill a pin hole, if any, in the protection insulating layer formed through anodizing and to reduce the insulating cross capacity of the lower electrode 11 and the scanning line 21.

Metal films 17, 18, and 19 serving as the scanning line 21 were deposited on the interlayer film 15 through sputtering, for example. Three or more layers were formed as the metal films. An alloy of Cr including 30 wt % or higher of Mo was used for the metal film lower layer 17, Al was used for the metal film intermediate layer 18, and Cr was used for the metal film upper layer 19, for example. Since the metal film lower layer 17 and the metal film upper layer 19 have a high tensile stress, and increased thickness may lead to stripping of wire to cause defect, they were formed to have a thickness of approximately 100 nm. Al was formed to have the largest possible thickness to reduce the wire resistance. In this case, the metal film lower layer 17, the metal film intermediate layer 18, and the metal film upper layer 19 had thicknesses of 100 nm, 4 μm, and 100 nm, respectively.

Then, as shown in FIG. 8, the metal film upper layer 19 was processed to have a stripe shape orthogonal to the lower electrode 11 through patterning and etching steps of a resist. The etching needs to process selectively the metal film upper layer 19 without damaging the Al intermediate layer. For example, wet etching can be used with aqueous solution of diammonium cerium (V) nitrate.

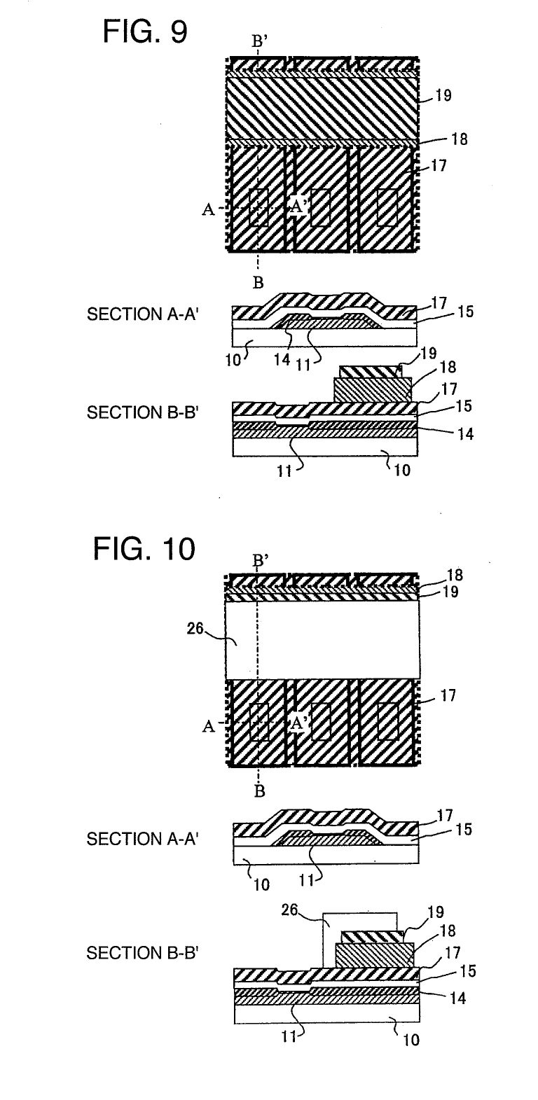

Next, as shown in FIG. 9, the metal film intermediate layer 18 was processed through patterning and etching steps of a resist. The etching needs to selectively process the metal film intermediate layer 18 without damaging the metal film upper layer 19 and the metal film lower layer 17. For example, wet etching was performed with a mixed solution of phosphoric acid, acetic acid, and nitric acid. The electrode width of the metal film upper layer 19 was formed to be smaller than the electrode width of the metal film intermediate layer 18 to prevent the metal film upper layer 19 from forming a canopy shape.

Next, as shown in FIG. 10, the resist film 26 was used to perform patterning.

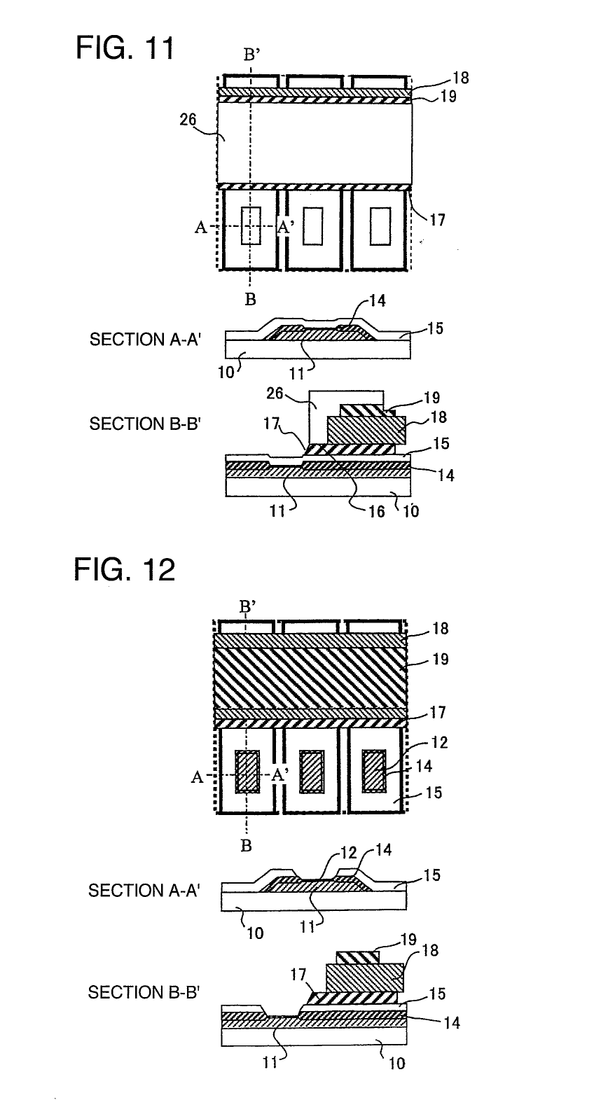

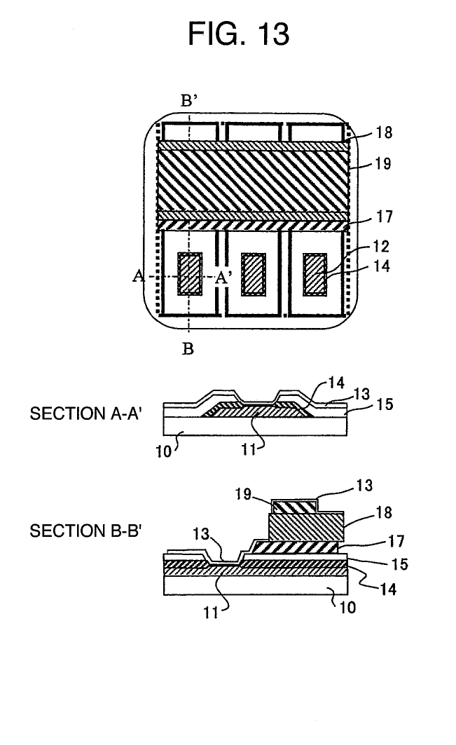

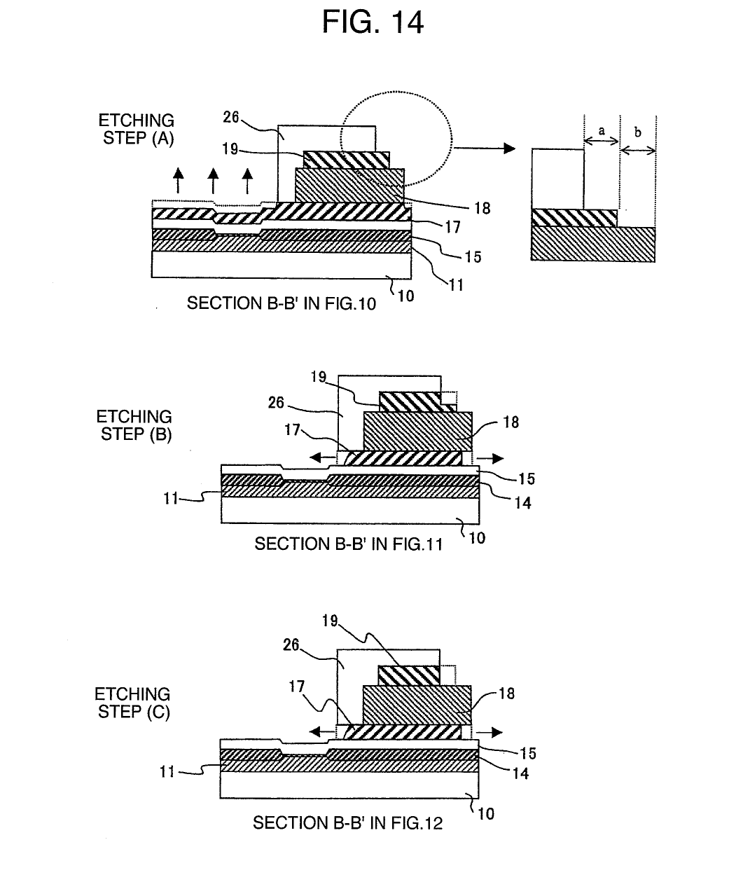

Then, as shown in FIG. 11, the metal film lower layer 17 was processed through etching. For example, the wet etching was performed with a solution of diammonium cerium (V) nitrate. In this case, one side of the metal film lower layer 17 (the left side in the section view taken along the line B-B′ in FIG. 11) was protruded from the metal film intermediate layer 18 to provide a flat contact portion 16 for ensuring connection to the upper electrode in a subsequent step. The opposite side of the metal film lower layer 17 was used to form an undercut by using the metal film intermediate layer 18 as a mask to provide a canopy of the metal film intermediate layer 18. When the upper electrode 13 is deposited later, the canopy can be used to separate from an adjacent (the right side in the section view taken along the line B-B′ in FIG. 11).

When the metal film lower layer 17 is processed through wet etching, the etching rate significantly depends on the areas of the portions of the upper layer 19, the intermediate layer 18, and the lower layer 17 in contact with the etchant.

Thus, as shown in FIG. 14, the etching is considered in three separate steps. In a first step (A), the metal film lower layer 17 is etched in the thickness direction. In a second step (B), the side etching proceeds. In a third step (C), the exposed portion of the upper layer Cr is completely etched. In the third step in which the area of the portion of the Al intermediate layer 18 in contact with the etchant is sufficiently large relative to the areas of the portions of the upper layer 19 and the lower layer 17 in contact with the etchant, the etching of the lower layer 17 is stopped. In other words, the processing must be finished before the step (C) in order to provide the sufficient amount of the side etching.

In practice, if the amount of the side etching is three times larger than the thickness of the lower layer 17, stable separation can be achieved after the deposition of the upper electrode 13 through sputtering. When the etching is performed with electric connection between Cr and CrMo, cell reaction occurs. As a result, the lower layer 17 is dissolved in oxidation reaction, and cerium (IV) in the etchant is reduced on the surface of the upper layer Cr. Thus, the lower layer 17 can be etched selectively.

In the step (A) in which the exposed area of the lower layer 17 is sufficiently large relative to the exposed area of the upper layer 19, the etching rate of the CrMo alloy of the lower layer 17 is significantly higher than the rate of Cr of the upper layer 19, and the etching of the upper layer 19 is ignorable in the step (A). To provide the amount of the side etching three times larger than the thickness, in the step (B), the amount of the side etching must be three times larger than the thickness before the etching of the upper layer 19 is finished in the thickness direction. In other words, the ratio of the etching rate between the upper layer 19 and the lower layer 17 needs to be three or more.

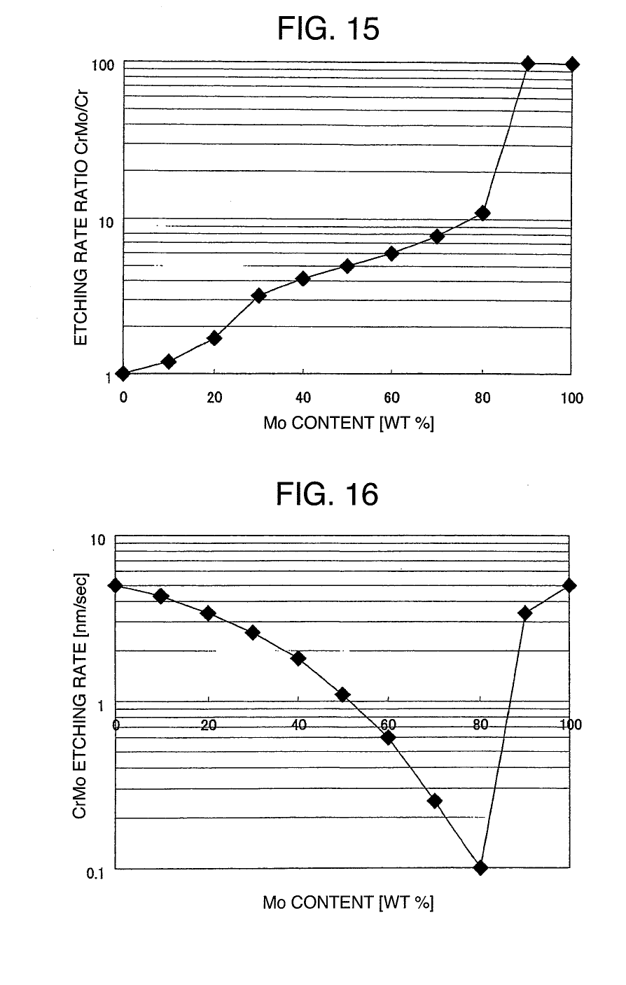

FIG. 15 shows the etching rate ratio of the CrMo alloy in the lower layer and the Cr in the upper layer in the step (B) shown in FIG. 14 when the lower layer, the aluminum layer, and the upper layer have thicknesses of 100 nm, 4500 nm, and 100 nm, respectively, and a=b=5 μm (see the upper right in FIG. 14).

It is shown from FIG. 15 that 30 wt % or higher of Mo corresponding to three or more of the etching rate can provide sufficient side etching and form the picture element separating structure. However, as apparent from FIG. 16, 60 to 85 wt % of Mo is not preferable in practice since the etching rate of the CrMo alloy is considerably reduced. In addition, the upper layer 19 has a step after the completion of the etching. Thus, the content of Mo from 30 to 60 wt % is preferable in practice.

Then, as shown in FIG. 12, the interlayer film 15 was processed to open the electron emitting portion. The electron emitting portion was formed in part of the intersection in space sandwiched between the single lower electrode 11 in the pixel and the two scanning lines 21 orthogonal to the lower electrode 11. For example, dry etching was performed with CF₄ or SF₆ as a main component.

Finally, as shown in FIG. 13, the upper electrode film 13 was deposited. For example, sputtering was used for the deposition. As the upper electrode 13, for example, a stacked film of Ir, Pt, and Au was used with a thickness of 6 nm. In this case, the upper electrode 13 can be cut by means of the canopy structure formed through the side etching of the lower layer.

Example 1 can control the local cell action to stably form the canopy mechanism, thereby providing the picture element separation in the upper electrode. Also, Al is a material having oxidation resistance and can be resistant to the subsequent manufacture step at high temperature. Thus, the image display can be produced.

### EXAMPLE 2

Example 2 describes the case where a CrMo layer in a lower layer and an Al or Al alloy layer in an intermediate layer are collectively etched.

The structure of a scanning line of Example 2 is provided by sandwiching the Al or Al alloy intermediate layer between the CrMo alloy layer including 92 to 97.5 wt % of Mo and a Cr layer. The CrMo alloy layer is placed closer to a cathode substrate 10.

The abovementioned structure can be used to form a picture element separating structure in the scanning line. In addition, preferable electrical connection is achieved between the scanning line and an upper electrode. The manufacture process of the scanning line of Example 2 will hereinafter be described.

Before the deposition of an interlayer film 15, similar steps are performed to the manufacture process in Example 1 from FIGS. 3 to 6. After the deposition of the interlayer film 15, as shown in FIG. 7 of Example 1, metal films 17, 18, and 19 serving as a scanning line 21 were deposited through sputtering.

The metal film lower layer 17 can be formed by using an alloy of CrMo including 92 to 97.5 wt % of Mo. In this case, an alloy of CrMo including 95% of Mo was used. Al or an Al alloy was used for the intermediate layer 18. Cr was used for the upper layer 19. The metal film lower layer, the metal film intermediate layer 18, and the metal film upper layer 19 were formed to have thicknesses of 100 nm, 4 μm, and 100 nm, respectively.

Then, as shown in FIG. 8 of Example 1, the metal film upper layer 19 was processed to have a stripe shape orthogonal to a lower electrode 11 through a patterning step and an etching step of a resist. The metal film upper layer 19 needs to be selectively etched relative to the Al intermediate layer. For example, wet etching can be used with a solution of diammonium cerium (V) nitrate.

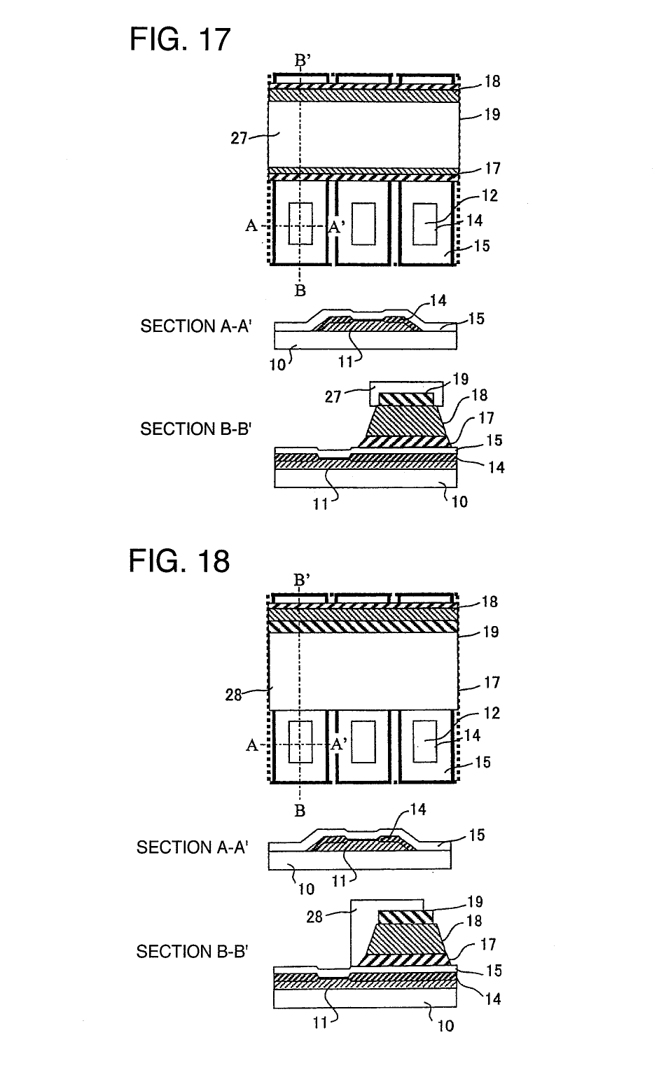

Next, as shown in FIG. 17, Al in the metal film intermediate layer 18 and the metal film lower layer 17 were collectively processed to have a tapered shape through a patterning step and an etching step of a resist film 27. The tapered shape is effective in connection to the upper electrode deposited in a subsequent step. The electrode width of the metal film upper layer 19 was formed to be smaller than the electrode width of the metal film intermediate layer 18 to prevent the metal film upper layer 19 from forming a canopy shape.

To process collectively the intermediate layer 18 and the lower layer 17 into the tapered shape, the etching rate of the intermediate layer 18 made of Al needs to be higher than the etching rate of the lower layer 17.

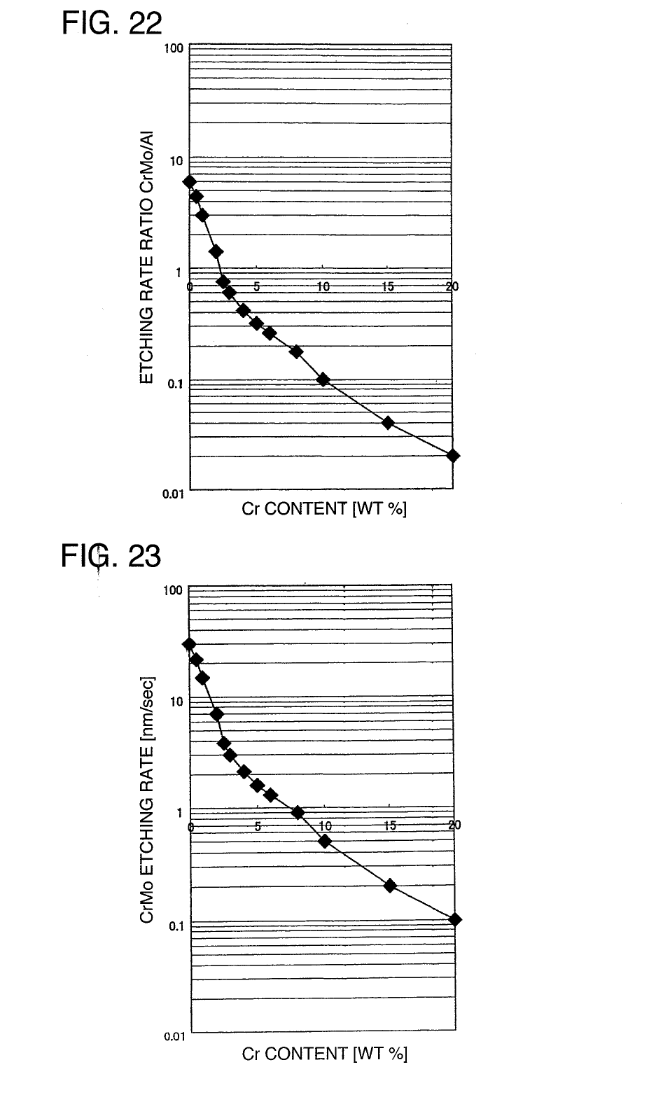

FIG. 22 shows the relationship between the etching rate ratio of the intermediate layer 18 and the lower layer 17 and the content of Cr in the CrMo alloy of the lower layer 17 when the etching is performed with a mixed solution of phosphoric acid, acetic acid, and nitric acid.

It is shown from FIG. 22 that the content of Cr should be 2.5 wt % or higher in order to provide the etching rate ratio of one or lower. In other words, 97.5 wt % or lower of Mo of the CrMo alloy in the lower layer 17 can achieve the collective etching with the mixed solution of phosphoric acid, acetic acid, and nitric acid, and can provide the tapered shape.

However, as apparent from FIG. 23, the content of Cr of 8 wt % or higher (with the content of Mo of 92 wt % or lower) is not preferable in practice since the etching rate of the CrMo alloy is significantly reduced. Thus, 2.5 to 8 wt % of Cr (92 to 97.5 wt % of Mo) is preferable. The upper layer 19 is characterized by having a step after the completion of the etching.

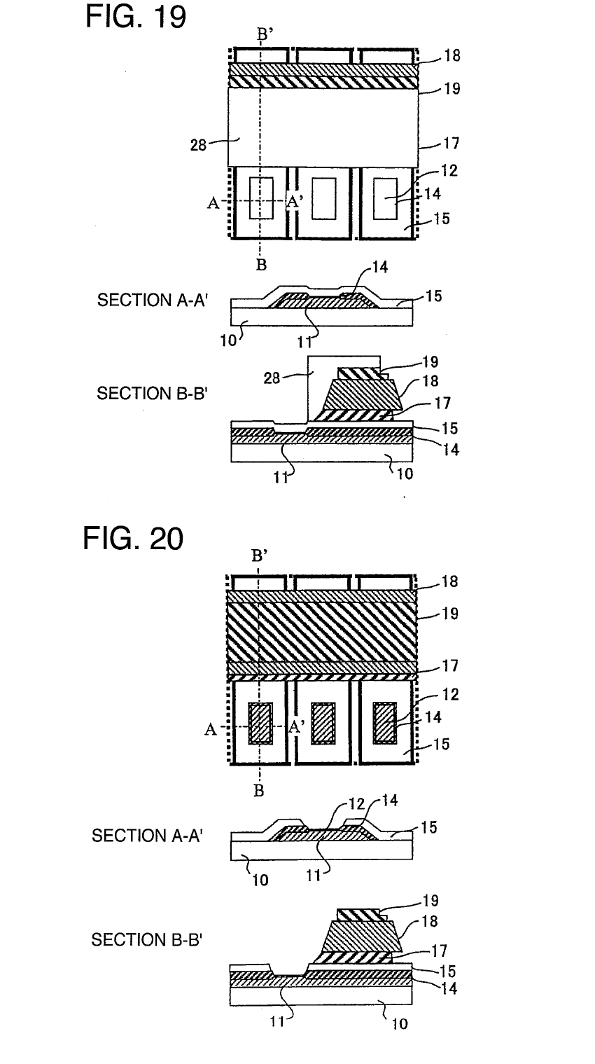

Then, as shown in FIG. 18, a resist film 28 was patterned. The side later connecting to the upper electrode was completely covered with the resist film 28 and only the side closer to the picture element separating structure was exposed. The side etching was performed as in Example 1 with a solution of diammonium cerium (V) nitrate. The side etching was performed to provide a canopy structure as shown in FIG. 19.

Next, as shown in FIG. 20, the intermediate film 15 was processed to open an electron emitting portion. The electron emitting portion was formed in part of the intersection in space sandwiched between the single lower electrode 11 in the pixel and the two scanning lines 21 orthogonal to the lower electrode 11. For example, dry etching was performed with CF₄ or SF₆ as a main component.

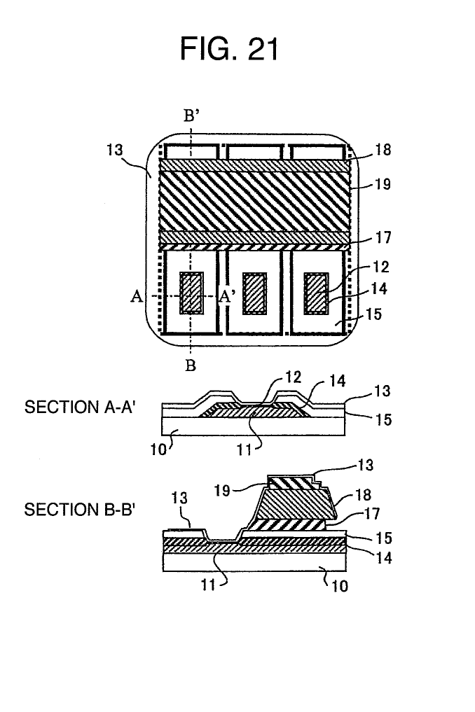

Finally, as shown in FIG. 21, an upper electrode film 13 was deposited. For example, sputtering was used for the deposition. As the upper electrode 13, for example, a stacked film of Ir, Pt, and Au was used with a thickness of 6 nm. In this case, the upper electrode 13 can be cut by means of the canopy structure formed through the side etching of the lower layer. The opposite side of the scanning line 21 to the canopy structure had the tapered shape formed of the lower layer 17 and the intermediate layer 18, and the electronic sources can be powered without disconnecting the upper electrode.

### EXAMPLE 3

Example 3 describes the case where an alloy of MoCrNi for the lower layer is provided by the addition of Ni to a MoCr layer in the lower layer when a lower layer and an intermediate layer are collectively etched as in Example 2.

The addition of Ni to the CrMo alloy (2.5 to 8 wt % of Cr) improves oxidation resistance for heat in a subsequent manufacture step. When an oxidized film is formed on the surface of a tapered shape in the lower layer by heating in an air atmosphere at 400° C. used in a panel sealing step, contact resistance occurs with an upper electrode formed on the surface of the tapered shape. Thus, a smaller thickness of the surface oxidation film after the heating is preferable.

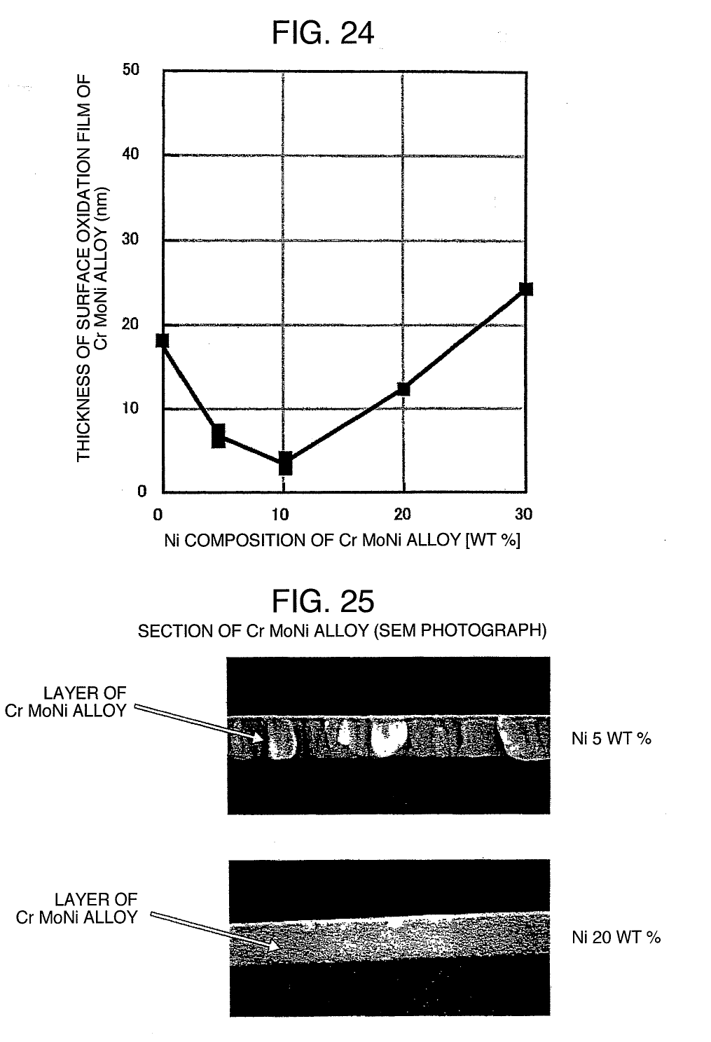

FIG. 24 shows the relationship between the amount of added Ni and the thickness of the surface oxidation film when the MoCrNi alloy includes 5 wt % of Cr. As shown in FIG. 24, the amount of added Ni should be 25 wt % or lower in order to maintain the oxidation resistance, and the thickness of the surface oxidation film is minimized particularly at approximately 10 wt % of Ni. When 20 wt % of Ni is added as in a SEM photograph shown in FIG. 25, it becomes amorphous and is effective in electrical connection to the upper electrode.

As described above, Example 1 can control the local cell action to stably form the canopy mechanism in the scanning line 21, thereby providing the picture element separation in the upper electrode. Examples 2 and 3 can have the tapered shape on the side of the scanning line 21 opposite to the canopy structure to power the electronic source without disconnecting the upper electrode. Al used in the present invention is resistant to oxidation and can withstand the subsequent manufacture step at high temperature. Thus, the image display can be produced.

It should be further understood by those skilled in the art that although the foregoing description has been made on embodiments of the invention, the invention is not limited thereto and various changes and modifications may be made without departing from the spirit of the invention and the scope of the appended claims.

1. An image display comprising:
a lower electrode;
an upper electrode;
an electron accelerating layer sandwiched between the lower electrode and the upper electrode;
a display panel formed of a cathode substrate including an array of thin film electronic sources which emit electrons from the side of the upper electrode in response to a voltage applied between the lower electrode and the upper electrode, and a fluorescent surface substrate having a fluorescent material formed thereon to emit light through excitation by the electrons;
a driving circuit driving the lower electrode and the upper electrode; and
an upper bus electrode powering the upper electrode and formed of three or more stacked films formed by sandwiching aluminum or an alloy of aluminum between a layer made of chromium and a layer of an alloy of chromium and molybdenum, the alloy of chromium and molybdenum including 30 wt % or more of molybdenum.

2. The image display according to claim 1, wherein the layer of the alloy of chromium and molybdenum is protruded from the aluminum or the alloy of aluminum to connect to the upper electrode on one side of the upper bus electrode, and forms an undercut relative to the aluminum or the alloy of aluminum to provide separation of the upper electrode for each upper bus electrode on the other side.

3. The image display according to claim 1, wherein the layer of the alloy of chromium and molybdenum is connected to the upper electrode in a flat contact portion protruded from the aluminum or the alloy of aluminum on one side of the upper bus electrode, and forms an undercut relative to the aluminum or the alloy of aluminum to provide separation of the upper electrode for each upper bus electrode on the other side.

4. The image display according to claim 1, wherein the layer of the alloy of chromium and molybdenum includes 60 wt % or lower of molybdenum.

5. The image display according to claim 1, wherein the upper bus electrode is used as a scanning line in matrix driving.

6. An image display comprising:
a lower electrode;
an upper electrode;
an electron accelerating layer sandwiched between the lower electrode and the upper electrode;
a display panel formed of a cathode substrate including an array of thin film electronic sources which emit electrons from the side of the upper electrode in response to a voltage applied between the lower electrode and the upper electrode, and a fluorescent surface substrate having a fluorescent material formed thereon to emit light through excitation by the electrons;
a driving circuit driving the lower electrode and the upper electrode; and
an upper bus electrode powering the upper electrode and formed of three or more stacked films formed by sandwiching aluminum or an alloy of aluminum between a layer made of chromium and an alloy of chromium and molybdenum, the alloy of chromium and molybdenum including not less than 2.5 wt % to not more than 8 wt % of chromium.

7. The image display according to claim 6, wherein the layer of the alloy of chromium and molybdenum is protruded from the aluminum or the alloy of aluminum to connect to the upper electrode on one side of the upper bus electrode, and forms an undercut relative to the aluminum or the alloy of aluminum to provide separation of the upper electrode for each upper bus electrode on the other side.

8. The image display according to claim 6, wherein the layer of the alloy of chromium and molybdenum is connected to the upper electrode in a tapered shape protruded from the aluminum or the alloy of aluminum in a tapered shape on one side of the upper bus electrode, and forms an undercut relative to the aluminum or the alloy of aluminum to provide separation of the upper electrode for each upper bus electrode on the other side.

9. The image display according to claim 6, wherein the upper bus electrode is used as a scanning line in matrix driving.

10. An image display comprising:
a lower electrode;
an upper electrode;
an electron accelerating layer sandwiched between the lower electrode and the upper electrode;
a display panel formed of a cathode substrate including an array of thin film electronic sources which emit electrons from the side of the upper electrode in response to a voltage applied between the lower electrode and the upper electrode, and a fluorescent surface substrate having a fluorescent material formed thereon to emit light through excitation by the electrons;
a driving circuit driving the lower electrode and the upper electrode; and
an upper bus electrode powering the upper electrode and formed of three or more stacked films formed by sandwiching aluminum or an alloy of aluminum between a layer made of chromium and an alloy of chromium, molybdenum, and nickel, the alloy of chromium, molybdenum, and nickel including not less than 2.5 wt % to not more than 8 wt % of chromium and 25 wt % or more of nickel.

11. The image display according to claim 10, wherein the layer of the alloy of chromium and molybdenum is protruded from the aluminum or the alloy of aluminum to connect to the upper electrode on one side of the upper bus electrode, and forms an undercut relative to the aluminum or the alloy of aluminum to provide separation of the upper electrode for each upper bus electrode on the other side.

12. The image display according to claim 10, wherein the layer of the alloy of chromium and molybdenum is connected to the upper electrode in a tapered shape protruded from the aluminum or the alloy of aluminum in a tapered shape on one side of the upper bus electrode, and forms an undercut relative to the aluminum or the alloy of aluminum to provide separation of the upper electrode for each upper bus electrode on the other side.

13. The image display according to claim 10, wherein the upper bus electrode is used as a scanning line in matrix driving.
